(19) United States
(12) Patent Application Publication
(10) Pub. No.: US 2020/0298386 A1
(43) Pub. Date: Sep. 24, 2020

(54) DRIVING-IN DEVICE

(71) Applicant: HILTI AKTIENGESELLSCHAFT, Schaan (LI)

(72) Inventor: Emanuel KURTH, Chur (CH)

(21) Appl. No.: 16/769,421

(22) PCT Filed: Dec. 5, 2018
(86) PCT No.: PCT/EP2018/083635

§ 371 Date: Jun. 3, 2020

(30) Foreign Application Priority Data
Dec. 21, 2017 (EP) 17209401.3

(51) Int. Cl. B25C 1/00; B25C 1/06

(52) U.S. Cl. CPC B25C 1/005; B25C 1/188; B25C 1/06

(57) ABSTRACT

An apparatus for driving a fastening element into an underlying surface, the apparatus having a center of gravity, an energy transmission element, which is movable between a starting position and a setting position, for transmitting driving-in energy to the fastening element, a piston drive that provides driving-in energy, a housing, and a bolt guide that guides the fastening element while it is being driven in, wherein the bolt guide is mounted on the housing in a rotatable manner with respect to rotation about the center of gravity.

### TECHNICAL FIELD

The application relates to an apparatus for driving a fastening element into an underlying surface.

### BACKGROUND OF THE INVENTION

Such apparatuses usually have a piston for transmitting energy to the fastening element. The energy required for this has to be made available in a very short time, which is why, for example in the case of what are known as spring nailers, first of all a spring is tensioned, said spring, during the driving-in operation, imparting the tensile energy to the piston in a sudden burst and accelerating the latter onto the fastening element.

The energy released in a sudden burst, with which the fastening element is driven into the underlying surface, causes a recoil, which mechanically loads some components of such apparatuses. When a center of gravity of the apparatus does not lie on the path of movement of the piston or in the extension thereof, the recoil comprises a torque, which causes the entire apparatus to tilt while the fastening element is being driven into the underlying surface.

### SUMMARY OF THE INVENTION

The object of the invention is to improve the fastening quality of the apparatus mentioned at the beginning.

The object is achieved by an apparatus for driving a fastening element into an underlying surface, having a center of gravity, an energy transmission element, which is movable between a starting position and a setting position, for transmitting driving-in energy to the fastening element, a piston drive that provides driving-in energy, a housing, and a bolt guide that guides the fastening element while it is being driven in, wherein the bolt guide is mounted on the housing in a rotatable manner with respect to rotation about the center of gravity. As a result of being mounted in a rotatable manner, the bolt guide remains in position on account of its mass inertia even when the rest of the apparatus is already tilting on account of the recoil. This applies for the period in which the fastening element is being driven into the underlying surface.

An advantageous embodiment is characterized in that the apparatus has a damping element, which damps a rotary movement of the bolt guide about the center of gravity.

An advantageous embodiment is characterized in that the bolt guide has a holder, which is mounted on the housing in a rotatable manner with respect to rotation about the center of gravity. Preferably, the holder comprises a deceleration element for braking the energy transmission element.

An advantageous embodiment is characterized in that the bolt guide is mounted on the housing in a rotatable manner through an angular range of at least 2°. Preferably, the angular range extends through at least 3°, particularly preferably through at least 5°.

### EMBODIMENTS OF THE INVENTION

Exemplary embodiments of an apparatus for driving a fastening element into an underlying surface are explained in more detail in the following text by way of examples with reference to the drawings, in which:

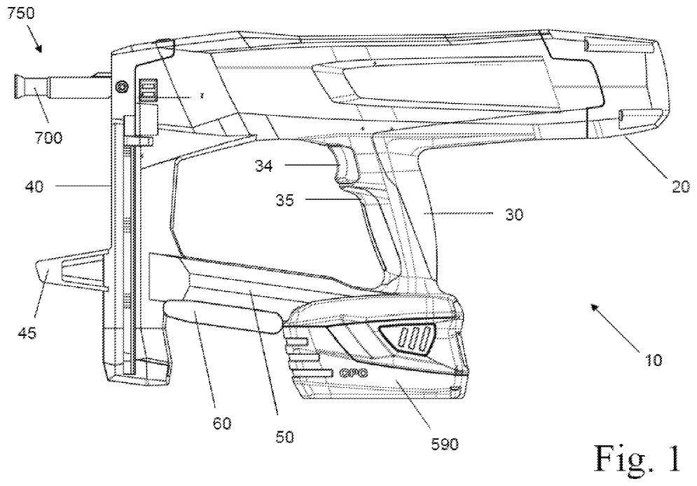

FIG. 1 shows a side view of a driving-in apparatus,

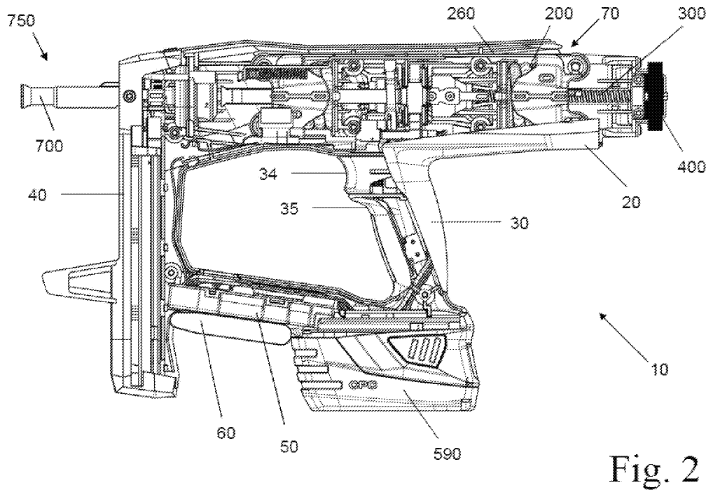

FIG. 2 shows a side view of a driving-in apparatus with the housing open,

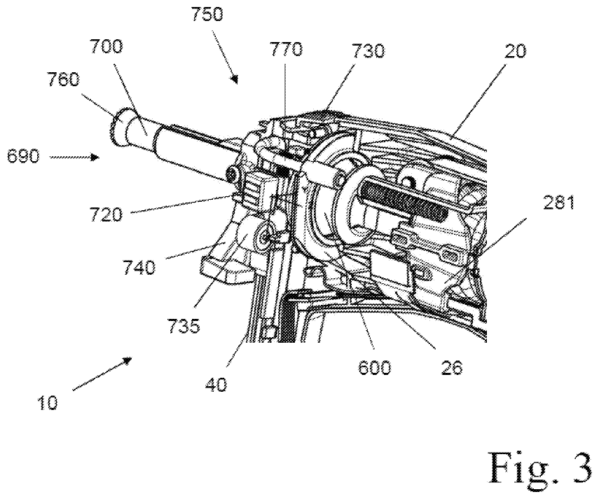

FIG. 3 shows a partial view of a driving-in apparatus,

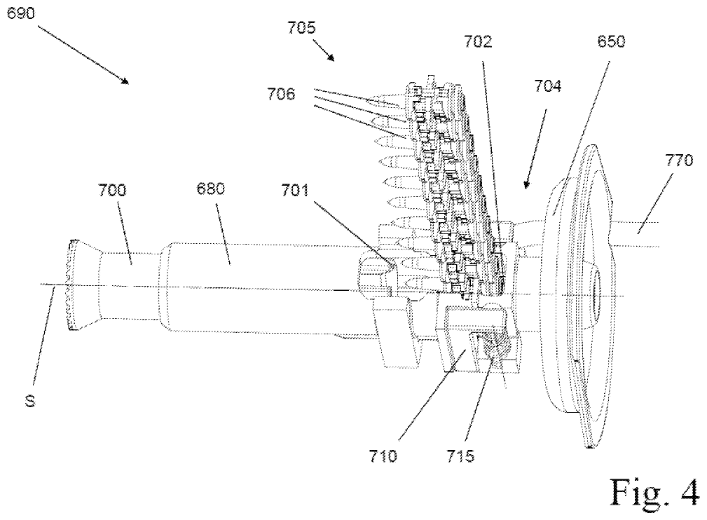

FIG. 4 shows an oblique view of a bolt guide, and

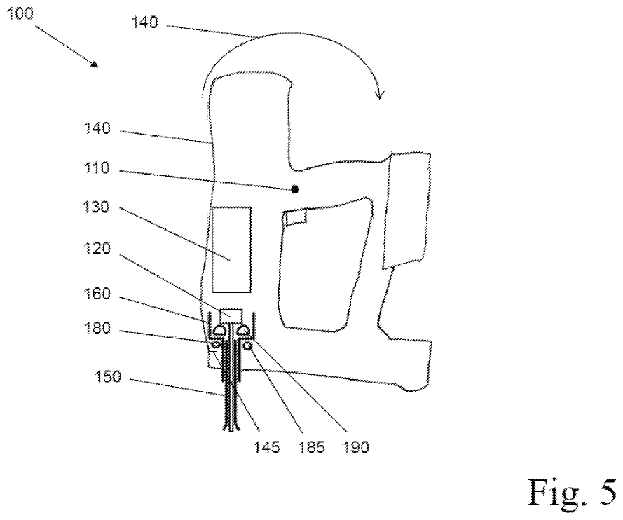

FIG. 5 shows a driving-in apparatus.

FIG. 1 shows a side view of a driving-in apparatus 10 for driving a fastening element, for example a nail or bolt, into an underlying surface. The driving-in apparatus 10 has an energy transmission element (not illustrated) for transmitting energy to the fastening element, and a housing 20, in which the energy transmission element and a drive device (likewise not illustrated) for advancing the energy transmission element are received.

The driving-in apparatus 10 also has a handle 30, a magazine 40 and a bridge 50 connecting the handle 30 to the magazine 40. The magazine is not removable. Fastened to the bridge 50 are a scaffold hook 60 for hanging the driving-in apparatus 10 on a scaffold or the like, and an electrical energy store in the form of a rechargeable battery 590. Arranged on the handle 30 are a trigger 34 and a grip sensor in the form of a manual switch 35. Furthermore, the driving-in apparatus 10 has a guide duct 700 for guiding the fastening element and a pressing device 750 for identifying a distance of the driving-in apparatus 10 from an underlying surface (not illustrated). Alignment of the driving-in apparatus perpendicularly to an underlying surface is assisted by an alignment aid 45.

FIG. 2 shows the driving-in apparatus 10 with the housing 20 open. Received in the housing 20 is a drive device 70 for advancing an energy transmission element that is concealed in the drawing. The drive device 70 comprises an electric motor (not illustrated) for converting electrical energy from the rechargeable battery 590 into rotational energy, a torque transmission device, comprising a gear mechanism 400, for transmitting a torque of the electric motor to a motion converter in the form of a spindle drive 300, a force transmission device, comprising a roller train 260, for transmitting a force from the motion converter to a mechanical energy store in the form of a spring 200 and for transmitting a force from the spring to the energy transmission element.

FIG. 3 shows an oblique view of the driving-in apparatus 10 with the housing 20 open. In the housing, the front roller holder 281 can be seen. The deceleration element 600 is kept in its position by the holding ring 26. The nose 690 has, inter alia, the contact pressure sensor 760 and the unblocking element 720. The pressing device 750 has the guide duct 700, which preferably comprises the contact pressure sensor 760, and the connecting rod 770. The magazine 40 has the feeding element 740 and the feeding spring 735.

Furthermore, the driving-in apparatus 10 has an unlocking switch 730 for unlocking the guide duct 700 such that the guide duct 700 is removable, for example to make it easier to remove jammed fastening elements.

FIG. 4 shows an oblique view of a nose 690 of an apparatus for driving a fastening element into an underlying surface. The nose 690 comprises a guide duct 700 for guiding the fastening element, having a rear end side 701 and a holder 650, which is arranged so as to be displaceable toward the setting axis relative to the guide duct 700, for holding a deceleration element (not illustrated). The holder 650 has a bolt receptacle 680 with a feed cutout 704, through which a nail strip 705 with a multiplicity of fastening elements 706 is feedable to a firing portion 702 of the guide duct 700. The guide duct 700 serves at the same time as a contact pressure sensor of a pressing device, which has a connecting rod 770, which is likewise displaced during a displacement of the guide duct 700 and thus indicates contact pressure of the apparatus with an underlying surface.

FIG. 5 shows a driving-in apparatus 100 having a center of gravity 110, an energy transmission element 120, which is movable between a starting position and a setting position, for transmitting driving-in energy to a fastening element (not shown), a piston drive 130 that provides the driving-in energy, a housing 140, and a bolt guide 150 that guides the fastening element while it is being driven in. The bolt guide 150 has a holder 160 and is mounted on the housing 140 only via the holder 160. The holder 160 is connected to the rest of the bolt guide 150 so as to rotate therewith. With respect to rotation about the center of gravity 110, the holder 160 and thus the bolt guide 150 are mounted on the housing 140 in a rotatable manner. As a result of being mounted in a rotatable manner, the bolt guide remains standing on the underlying surface on account of its mass inertia in the period in which the fastening element is being driven into the underlying surface, and ensures guidance of the fastening element until the fastening element has been driven into the underlying surface. A rotary movement 170, caused by a recoil, of the driving-in apparatus 100, in particular of the housing 140, is compensated and the fastening quality is improved.

A driving-in apparatus 100 has a damping element 180, which is arranged on the side of the holder 160 remote from the center of gravity 110, in front of the holder 160 and behind a supporting element 145 of the housing 140, and therefore, during a recoil, a rotary movement of the bolt guide 150 about the center of gravity 110 relative to the housing 140 is damped. For symmetric mounting of the bolt guide 150, the driving-in apparatus 100 has a further damping element 185, which is arranged on the side of the holder 160 facing the center of gravity 110 and therefore makes no significant contribution to damping a rotary movement of the bolt guide 150 during a recoil.

An angular range through which the bolt guide is mounted on the housing in a rotatable manner depends on a distance between the holder 160 and the supporting element 145 and is 5° in the present case. The holder 160 otherwise comprises a deceleration element 190 for braking the energy transmission element 120.

1. An apparatus for driving a fastening element into an underlying surface, the apparatus having a center of gravity; an energy transmission element, which is movable between a starting position and a setting position, for transmitting driving-in energy to the fastening element; a piston drive that provides driving in energy; a housing; and a bolt guide that guides the fastening element while it is being driven in, wherein the bolt guide is mounted on the housing in a rotatable manner with respect to rotation about the center of gravity.

2. The apparatus as claimed in claim 1, wherein the apparatus has a damping element, which damps a rotary movement of the bolt guide about the center of gravity.

3. The apparatus as claimed in claim 1, wherein the bolt guide has a holder, which is mounted on the housing in a rotatable manner with respect to rotation about the center of gravity.

4. The apparatus as claimed in claim 1, wherein the holder comprises a deceleration element for braking the energy transmission element.

5. The apparatus as claimed in claim 1, wherein the bolt guide is mounted on the housing in a rotatable manner through an angular range of at least 2°.

6. The apparatus of claim 1, wherein the bolt guide is mounted on the housing in a rotatable manner through an angular range of at least 3°.

7. The apparatus of claim 1, wherein the bolt guide is mounted on the housing in a rotatable manner through an angular range of at least 5°.

8. The apparatus as claimed in claim 2, wherein the bolt guide has a holder, which is mounted on the housing in a rotatable manner with respect to rotation about the center of gravity.

9. The apparatus as claimed in claim 2, wherein the holder comprises a deceleration element for braking the energy transmission element.

10. The apparatus as claimed in claim 3, wherein the holder comprises a deceleration element for braking the energy transmission element.

11. The apparatus as claimed in claim 2, wherein the bolt guide is mounted on the housing in a rotatable manner through an angular range of at least 2°.

12. The apparatus as claimed in claim 3, wherein the bolt guide is mounted on the housing in a rotatable manner through an angular range of at least 2°.

13. The apparatus as claimed in claim 4, wherein the bolt guide is mounted on the housing in a rotatable manner through an angular range of at least 2°.

14. The apparatus of claim 2, wherein the bolt guide is mounted on the housing in a rotatable manner through an angular range of at least 3°.

15. The apparatus of claim 3, wherein the bolt guide is mounted on the housing in a rotatable manner through an angular range of at least 3°.

16. The apparatus of claim 4, wherein the bolt guide is mounted on the housing in a rotatable manner through an angular range of at least 3°.

17. The apparatus of claim 5, wherein the bolt guide is mounted on the housing in a rotatable manner through an angular range of at least 3°.

18. The apparatus of claim 2, wherein the bolt guide is mounted on the housing in a rotatable manner through an angular range of at least 5°.

19. The apparatus of claim 3, wherein the bolt guide is mounted on the housing in a rotatable manner through an angular range of at least 5°.

20. The apparatus of claim 4, wherein the bolt guide is mounted on the housing in a rotatable manner through an angular range of at least 5°.
